(19) United States
(12) Patent Application Publication
(10) Pub. No.: US 2012/0096996 A1
(43) Pub. Date: Apr. 26, 2012

(54) Fastener turning tool with a surface protective collar

(75) Inventors: Jason Scott Enos, Attleboro, MA (US); Chinawut Paesang, Attleboro, MA (US)

(73) Assignee: Ideology Products Developmenmt, Inc.

(21) Appl. No.: 13/200,638

(22) Filed: Sep. 27, 2011

Related U.S. Application Data
(60) Provisional application No. 61/455,483, filed on Oct. 22, 2010.

(51) Int. Cl. B25B 23/00

(52) U.S. Cl. 81/436

(57) ABSTRACT

A fastener turning tool has a handle with an extending shaft and a protective collar. A working end of the shaft is provided with a tip that is configured to engage a fastener. A longitudinally extending slot is formed in the shaft between the handle and the tip. The protective collar is slidably received on the extending shaft. A guide member fixed to said collar is slidably received in the longitudinally extending slot and constrains the collar for limited sliding on the shaft. A compression spring is held on the shaft between the collar and the handle. The spring is normally expanded and holds the collar down beyond the tool tip. When the collar is compressed, position, the tool tip is exposed for engagement with the fastener.

### CROSS-REFERENCE TO RELATED APPLICATIONS

Benefit is claimed under Title 35, United States Code §119(e) of U.S. Provisional Application No. 61/455,483, filed Oct. 22, 2010.

### BACKGROUND OF THE INVENTION

1. Field of Invention

The present invention relates to turning tools that are configured to turn fasteners, and more particularly, is directed toward a fastener turning tool with a surface protective collar for use with panel fasteners for securing and removing panels, the protective assembly preventing or minimizing damage to the panel in the event the turning tool is inadvertently disengaged from the panel fastener during use.

2. Description of the Prior Art

Panel fasteners are used to secure panels. For certain panel fastener, a driving tool, for example a screw driver, is used to tighten or loosen a panel fastener. If the screw driver slips off the panel fastener, the tip of the screw driver will contact and damage the panel finish. It is a costly and time-consuming task to refinish the damaged panel. A need has arisen for a panel turning tool with a protective assembly for preventing contact of the turning tool tip with the panel in the event that the tool inadvertently disengages from the fastener.

### SUMMARY OF THE INVENTION

It is an object of the present invention to provide a fastener turning tool with a protective collar that prevents a tip of the turning tool from contacting a panel member that is secured or is to be secured by the fastener in the event that the tool inadvertently slips off the fastener. A turning tool embodying the present invention for a fastener used to attach one member, for example a panel, to another member includes a handle with an extending shaft and a protective collar. A working end of the shaft is provided with a tip that is configured to engage the fastener. A longitudinally extending slot is formed in the shaft between the handle and the tip. The protective collar is slidably received on the extending shaft. A guide member fixed to the collar is slidably received in the longitudinally extending slot. The collar is constrained for limited sliding movement between downward and upward positions on the shaft by the guide member. In the downward position, the collar extends beyond the tool tip. In the upward position, the tip of the tool is exposed. A spring is held on the shaft between the collar and the handle. The spring is normally expanded and holds the collar in its downward position. When the collar is urged to its upward position, the spring is compressed and the tip of the tool is exposed. In operation of the tool, the collar is moved to its upward position, thus exposing the tip of the tool so that it can engage the fastener for securing or removing the panel. In the event that the tool tip slips off the fastener, the spring urges the collar downwardly so that the collar covers the tool tip and prevents damage to the panel.

Other objects of the present invention will in part be obvious and will in part appear hereinafter.

The invention accordingly comprises the apparatuses and systems, together with their parts, elements and interrelationships that are exemplified in the following disclosure, the scope of which will be indicated in the appended claims.

### BRIEF DESCRIPTION OF THE DRAWINGS

A fuller understanding of the nature and objects of the present invention will become apparent upon consideration of the following detailed description taken in connection with the accompanying drawings, wherein:

FIG. 1 is a perspective view of a fastener turning tool with a surface protective collar made in accordance with the invention, the collar being shown in its downward position;

FIG. 2 is a perspective view of the fastener turning tool of FIG. 1 with the surface protective collar being shown in its upward position;

FIG. 3 is a partial cutaway perspective view of the fastener turning tool of FIG. 1 to show details of the tool;

FIG. 4 is a partial cutaway perspective view of the fastener turning tool of FIG. 2 to show details of the tool;

FIG. 5 is a perspective view of the fastener turning tool of FIG. 2 ready to engage a panel fastener shown in phantom;

FIG. 6 is a perspective view of the fastener turning tool of FIG. 5 in engagement with engaging the panel fastener shown in phantom; and

FIG. 7 is an exploded perspective view showing details of the fastener turning tool of FIG. 1.

### DETAILED DESCRIPTION OF THE PREFERRED EMBODIMENTS

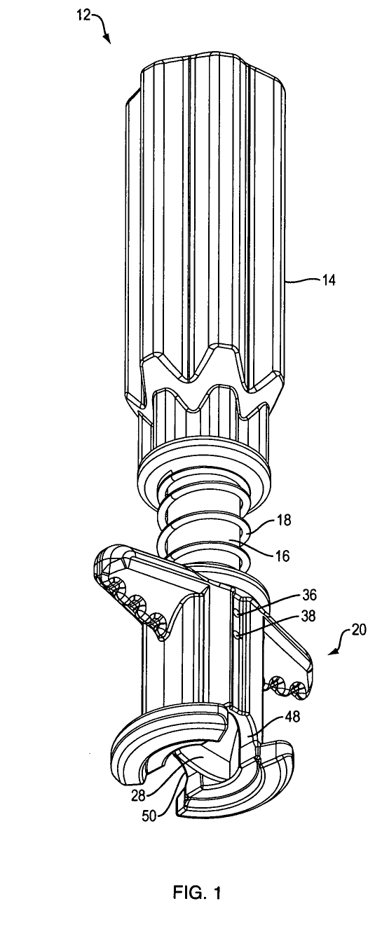

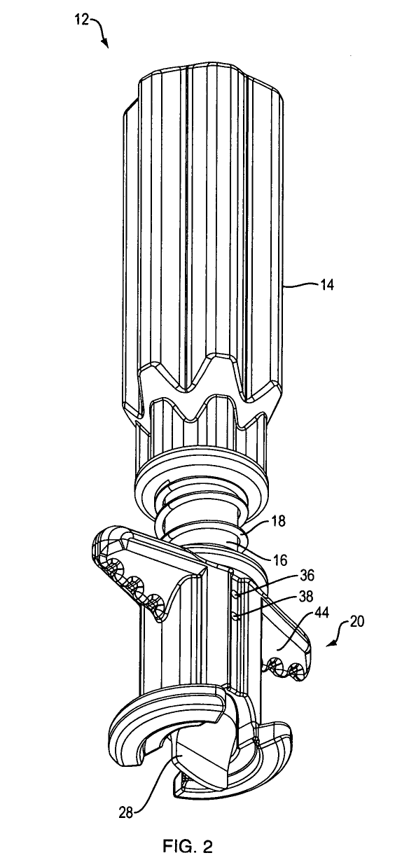

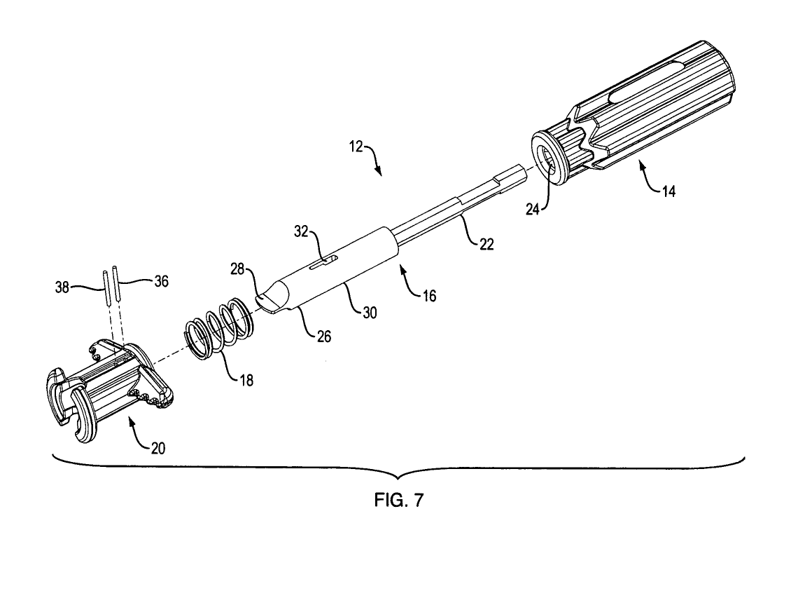

Referring now to the drawings, particularly FIGS. 1, 2 and 7, there is shown a fastener turning tool 12 embodying the present invention. Fastener turning tool 12 includes a handle 14, a shaft 16, a biasing member 18 and a protective collar 20. An end portion 22 of shaft 16 is sized and shaped to be securely held in a bore 24 in handle 14. An opposite end portion 26 of shaft 16 is provided with a working tip 28, for example, a screw drive tip. A medial portion 30 of shaft 16 adjacent tip 28 is formed with a longitudinally extending channel 32 that extends from one side of shaft 16 to an opposite side of the shaft. Protective collar 20 is slidably received on shaft 16. Collar 20 is constrained for limited sliding movement on shaft 16 between a downward position shown in FIG. 1 and an upward position shown in FIG. 2 by a guide 34 that is received in channel 32. In the illustrated embodiment, by way of example, guide 32 is a pair of pins 36,38. Opposite ends of each pin 36,38 is fixed to opposite sides of collar 20, a medial portion of each pin is slidably received in channel 32. Pins 36 and 38 are disposed in space parallel relationship relative to one another. When collar 20 is in its downward position shown in FIG. 1, collar 20 extends below tip 28. When collar 20 is in its upward position shown in FIG. 2, tip 28 is exposed.

Biasing member 18, for example a spring, is positioned between collar 20 and handle 14. Spring 18 has expanded and compressed states. Spring 18 urges collar 20 to its downward position when in its expanded state. Spring 18 is moved to its compressed state by a user pushing down on handle 14. When spring 18 is in its compressed state, collar 20 is in its upward position and tip 28 is exposed.

As best shown in FIGS. 1, 2, 3 and 4, in the illustrated embodiment, collar 20 is a substantially cylindrical sleeve that is sized and shaped to be slidably received on medial portion 30 of shaft 16. Collar 20 includes an annular lip 40 at a lower end 42 and a grip 44 at an upper end 46 for facilitating movement of the collar by the user of the tool 12 for exposing tip 28. Lower end 42 of collar 20 is formed with a pair of substantially U-shaped openings 48 and 50, the open end of the U-shaped opening being at the lower end of the collar.

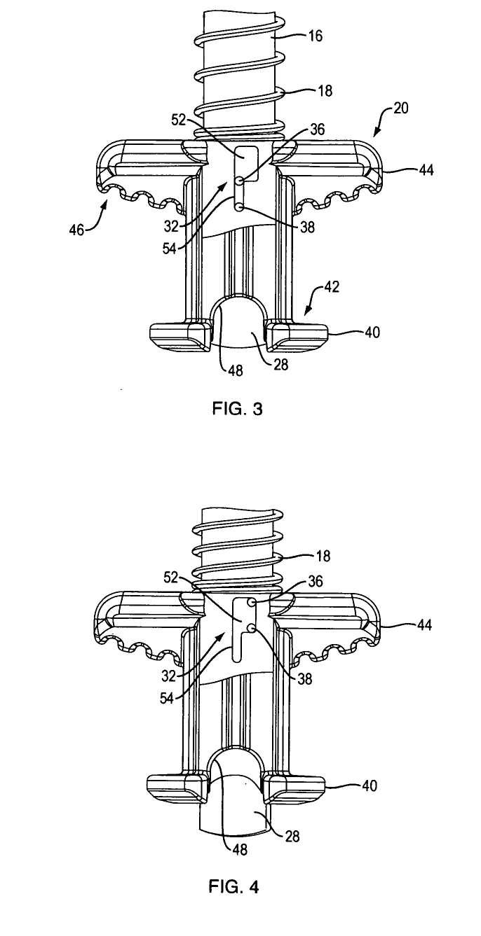

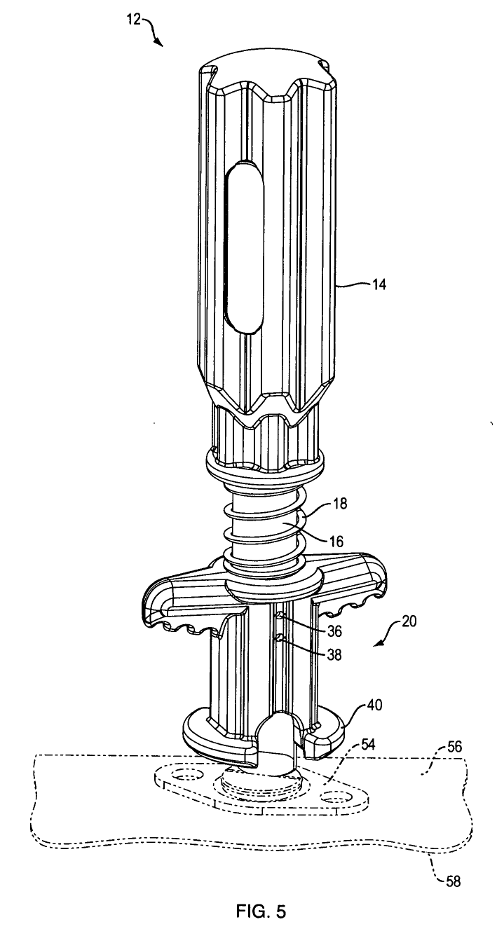

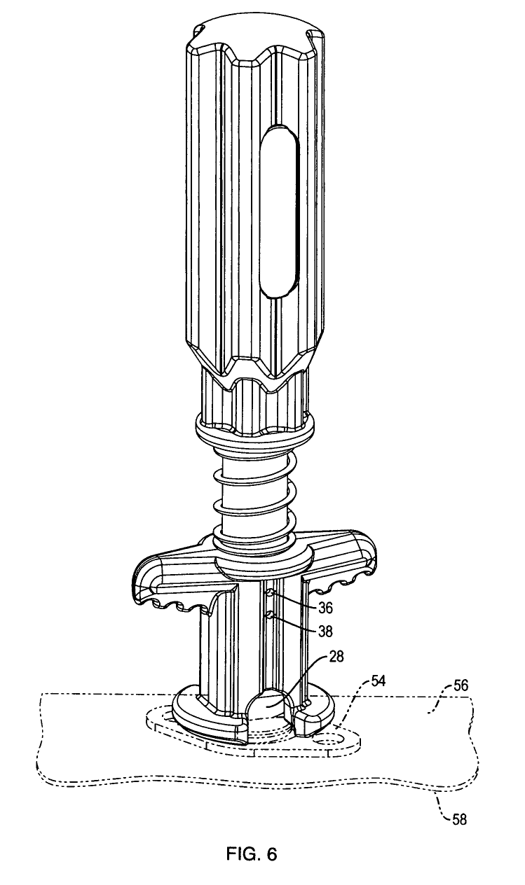

As best shown in FIGS. 3 and 4, in order to permit the user to expose tip 28 and tentatively hold collar 20 its upward position shown in FIG. 4, channel 32 is a substantially p-shaped channel having an enlarged head portion 52 and a narrow body portion 54, the enlarged head nearest handle 14. The corners of p-shaped channel 32 are rounded to facilitate movement of collar 20 to its downward position in the event that tip 28 unintentionally slips off of a fastener 54 that is used to secure a first panel 56 to a second member 58. Fastener 54, for example a panel fastener of the type sold under the trade name Dezus. Pins 36,38 are sized and shaped to be slidably received in said enlarged head 52 and said narrow body 54, when the user of the tool 12 moves collar 32 to its upward position by pulling up on grips 44 and turning handle 14. In this position shown in FIG. 4, tip 28 is exposed for engagement with fastener 54. Once tip 28 engages tip 28 and the user releases collar 20, pins 36,38 slide into narrow body portion 28 by the action of spring 18.

It is to be understood that, in an alternate embodiment, channel 32 is formed with narrow body portion 54 only and does not include enlarged head 52. In this embodiment, the user merely pulls grips 44 upwardly to expose tip 28 for engagement with fastener 54.

In operation of tool 12, a user pulls grip 44 upwardly toward handle 14 to expose tip 28. Tip 28 engages fastener 54. Grip 44 is released and spring 18 presses collar 20 against panel 56. Tool 12 is ready to secure panel 56 to member 58 or to disconnect panel 56 from member 58. In operation of tool 12, In the event that tip 28 slips off fastener 54, spring 18 urges collar 20 downwardly so that the collar covers the tip and prevents damage to panel 56.

Since certain changes may be made in the foregoing disclosure without departing from the scope of the invention herein involved, it is intended that all matter contained in the above description and depicted in the accompanying drawings be construed in an illustrative and not in a limiting sense.

What is claimed is:

1. A tool with a surface protective assembly, the tool being used to rotate a fastener for attachment of a first member to a second member, said tool and protective assembly comprising:
(a) a handle;
(b) a shaft having first and second ends, said first end of said shaft fixed to said handle, said second end of said shaft extending from said shaft, said extending portion of said shaft formed with a longitudinally extending channel;
(c) a turning head at said second end of said shaft, said turning head is configured to engage the fastener for attaching the first member to the second member
(d) a hollow collar slidably received on said extending shaft;
(e) a guide member fixed to said collar, said guide member sized and shaped to be slidably received in said longitudinally an extending channel in said shaft, said collar being constrained for limited movement between a first position and a second position relative to said shaft by said guide member received in said longitudinally extending channel, said collar extending beyond said turning head when in its first position and retracted to expose said turning head when in its second position;
(f) biasing means constrained between an upper end of said collar and a lower end of said handle, said biasing means having expanded and compressed states, said biasing means urging said collars to its first position when in its expanded state, said biasing means being in it's compressed when said collars is in its second position;
(g) when said turning head is moved into engagement with the fastener for attaching the first member to the second member, said biasing means is compressed and said collar is moved to its second position for exposing said turning head, said handle is turned for rotating the fastener and attaching the first member to the second member, in the event said turning head is unintentionally disengaged from the fastener, said biasing means forces said collar to slide to its first position and extend beyond said turning head, said collar presses against the first member, said turning head is out of contact with the first member, whereby said turning head is prevented from damaging the first member.

2. The tool as claimed in claim 1 wherein said collar includes an annular lip at a lower end, said lip providing a resting surface which presses against the first member when said turning head is unintentionally disengaged from the fastener for preventing the turning head from damaging the first member.

3. The tool as claimed in claim 1 wherein said channel is a substantially p-shaped channel having an enlarged head portion and a narrow body, said enlarged head nearest said handle, said guide member sized and shaped to be slidably received in said enlarged head and said narrow body, when a user of the tool moves said collar to its second position and moves said collar and handle are moved relative to one another in such a manner that said guide member is received in said enlarged head, said turning head is exposed for engagement with the fastener, once the fastener is engaged and the user releases said collar, said guide member is urged into said narrow body by said biasing means.

4. The tool as claimed in claim 3 wherein said collar includes a grip at an upper end for facilitating movement of said collar by the user of the tool for exposing said turning head.

5. The tool as claimed in claim 1 wherein said turning head is a screw driver head.

6. The tool as claimed in claim 1 wherein said guide member is a pair of pins, opposed ends of said pins are fixed in said collar, a medial portion of said pins is slidably received in said longitudinally extending channel in said shaft.

7. The tool as claimed in claim 1 where said biasing means is a spring.

8. A tool with a surface protective collar, the tool being used to rotate a fastener for attachment of a first member to a second member, said tool comprising:
(a) a handle and a shaft, said handle having a longitudinally extending chamber, said shaft having first and second ends, said first end of said shaft received in and fixed to said handle in said chamber, said second end of said shaft extending from said handle, a portion of said shaft extending from said handle is formed with a longitudinally extending channel, said channel disposed between said handle and said second end of said shaft, a turning head for engaging the fastener at said second end of said shaft;
(b) a protective collar formed with a longitudinally extending bore, said bore sized and shaped to be slidable received on said extending shaft;
(c) a guide member fixed to said collar, said guide member sized and shaped to be slidably received in said longitudinally extending channel in said shaft, said collar being constrained for limited sliding movement on said shaft between a first position and a second position by said guide member received in said slot, said collar extending beyond said turning head when in its first position and retracted to expose said turning head when in its second position;
(d) biasing means positioned between said collar and said handle, said biasing means having an expanded state and a compressed state, said biasing means urging said collar to its first position when in its expanded state, said biasing means being in its compressed state when said collar is in its second position;
(e) said turning head is configured to engage the fastener for attaching the first member to the second member, when said turning head engages the fastener, said collar is urged toward said handle, said biasing means is moved to its compressed state and said collar is moved to its second position, said handle is turned for rotating the fastener and attaching the first member to the second member, in the event said turning head is unintentionally disengaged from the fastener, said biasing means moves to its expanded state and forces said collar to slide to its first position and extend beyond said turning head, said collar presses against the first member, whereby said turning head is out of contact with the first member and is prevented from damaging the first member.

9. The tool as claimed in claim 8 wherein said collar includes an annular lip at a lower end, said lip providing a resting surface which presses against the first member when said turning head is unintentionally disengaged from the fastener for preventing said turning head from damaging the first member.

10. The tool as claimed in claim 9 wherein said turning head is a screw driver head.

11. The tool as claimed in claim 10 wherein said longitudinally extending channel is through channel that extends from one side of said shaft to an opposite side of said shaft.

12. The tool as claimed in claim 11 wherein said channel is a substantially p-shaped channel having an enlarged head portion and a narrow body, said enlarged head nearest said handle, said guide member sized and shaped to be slidably received in said enlarged head and said narrow body, when a user of the tool moves said collar to its second position and said collar and handle are moved relative to one another in such a manner that said guide member is received in said enlarged head, said screw drive head is exposed for engagement with the fastener, once the fastener is engaged and the user releases said collar, said guide member is urged into said narrow body by said biasing means.

13. The tool as claimed in claim 12 wherein said guide member is a pair of pins, opposed ends of said pins are fixed in said collar, a medial portion of each said pin is slidably received in said longitudinally extending channel in said shaft.

14. The tool as claimed in claim 9 wherein said collar includes a grip at an upper end for facilitating movement of said collar by the user of the tool for exposing said turning head.

15. A panel fastener tool with a surface protective collar, the tool being used to engage and disengage a panel fastener for attachment of a first member to a second member, said tool comprising:
(a) a handle and a shaft, said handle having a longitudinally extending chamber, said shaft having first and second ends, said first end of said shaft received in and fixed to said handle in said chamber, said second end of said shaft extending from said handle, a portion of said shaft extending from said handle is formed with a longitudinally extending channel extending from one side of said shaft to an opposite side of said shaft, said channel disposed between said handle and said second end of said shaft, a turning head for engaging the fastener at said second end of said shaft;
(b) a protective collar is slidably received on said extending shaft;
(c) a guide member fixed to opposite sides of said collar, a medial portion of said guide means disposed between said opposite sides of said guide member is sized and shaped to be slidably received in said longitudinally extending channel in said shaft, said collar being constrained for limited sliding movement on said shaft between a downward position and an upward position by said guide member received in said channel, said collar extending downwardly beyond said turning head when in its downward position and exposing said turning head when in its upward position;
(c) a spring positioned between said collar and said handle, said spring having expanded and compressed states, said spring urging said collar to its downward position when in its expanded state, said spring being in its compressed state when said collar is in its upward position;
(d) said turning head is configured to engage the fastener for attaching the first member to the second member, when said turning head engages the fastener, said collar is urged toward said handle, said spring is moved to its compressed state and said collar is moved to its upward position, said handle is turned for rotating the panel fastener and attaching the first member to the second member, in the event said turning head is unintentionally disengaged from the panel fastener, said spring means expands and forces said collar to slide downwardly and extend beyond said turning head, said collar pressing against the first member, whereby said turning head is out of contact with the first member and is prevented from damaging the first member.

16. The tool as claimed in claim 15 wherein said collar includes an annular lip at a lower end, said lip providing a resting surface which presses against the first member when said turning head is unintentionally disengaged from the fastener for preventing said turning head from damaging the first member.

17. The tool as claimed in claim 15 wherein said turning head is a screw driver head.

18. The tool as claimed in claim 15 wherein said channel is a substantially p-shaped channel having an enlarged head portion and a narrow body, said enlarged head nearest said handle, said guide member sized and shaped to be slidably received in said enlarged head and said narrow body, when a user of the tool moves said collar to its second position and said collar and handle are moved relative to one another in such a manner that said guide member is received in said enlarged head, said turning head is exposed for engagement with the fastener, once the fastener is engaged and the user releases said collar, said guide member is urged into said narrow body by said biasing means.

19. The tool as claimed in claim 18 wherein said guide member is a pair of pins, opposed ends of said pins are fixed in said collar, a medial portion of each said pin is slidably received in said longitudinally extending channel in said shaft.

20. The tool as claimed in claim 19 wherein said collar includes a grip at an upper end for facilitating movement of said collar by the user of the tool for exposing said turning head.
